(19) United States
(12) Patent Application Publication
(10) Pub. No.: US 2022/0386815 A1
(43) Pub. Date: Dec. 8, 2022

(54) SMART INDUCTIVELY-HEATED FOOD SERVICE DOME AND SMART DELIVERY SYSTEM

(71) Applicant: TSI Technologies LLC, Wichita, KS (US)

(72) Inventor: Brian Lee Clothier, Wichita, KS (US)

(21) Appl. No.: 17/831,965

(22) Filed: Jun. 3, 2022

Related U.S. Application Data
(60) Provisional application No. 63/258,883, filed on Jun. 4, 2021.

(51) Int. Cl. A47J 39/00; H05B 6/10; F28D 20/02; H05B 6/12; A47J 36/32; G06K 7/10; G06K 19/07; G06Q 10/08

(52) U.S. Cl. CPC A47J 39/006; H05B 6/105; F28D 20/021; H05B 6/1209; A47J 36/32; G06K 7/10366; G06K 19/0723; G06Q 10/083; H05B 2213/06

(57) ABSTRACT

A food delivery system comprising an induction heating apparatus, an induction-heatable apparatus, and a food delivery cart. The induction heating apparatus includes an induction heating element and an electronic system including a communication element configured to communicatively link to an ordering system. The induction-heatable apparatus is configured to be heated via the induction heating apparatus and includes an RFID tag configured to store information of food being heated and information of an intended recipient or intended destination of the food. The food delivery cart includes an induction heating element configured to warm the induction-heatable apparatus and hence the food and an electronic system including an RFID reader to determine information corresponding to the food, augment the information, and transmit the augmented information a central monitoring system.

### RELATED APPLICATIONS

The present patent application is a regular utility non-provisional patent application claiming priority benefit, with regard to all common subject matter, to U.S. Provisional Pat. App. Ser. No. 63/258,883, entitled “SMART INDUCTIVELY-HEATED FOOD SERVICE DOME AND SMART DELIVERY SYSTEM”, filed Jun. 4, 2021. The earlier-filed patent application is hereby incorporated by reference in its entirety into the present application.

### BACKGROUND

Food delivery systems are used to heat meals and deliver them to hospital patients, hotel guests, assisted living residents, and others. Such systems require cumbersome heating devices to ensure the meals are still warm upon delivery. Meals intended for delivery are poorly tracked, which may result in meals being delayed and delivered cold or not delivered at all. Furthermore, food service workers are often overwhelmed by inefficient delivery routes.

### SUMMARY

Embodiments of the invention solve the above-mentioned problems and other problems and provide a distinct advancement in the art of food delivery systems. More particularly, the invention provides a smart food delivery system for more efficient and comprehensive meal heating, delivery, and tracking.

An embodiment of the invention is a food delivery system broadly comprising a number of induction-heatable apparatuses including a number of foodservice domes and foodservice bases, a number of induction heating apparatuses and a number of food delivery carts. The food delivery system is configured to communicate and be used with an ordering system and a central monitoring system via a communication network. The food delivery system may also utilize various worker identification tags.

Each dome includes a top wall and a sidewall extending downward from an outer edge of the top wall. An underside of the top wall may also include a guide structure.

The guide structure may be protrusions, raised areas, tabs, or any other suitable features. The guide structure should have sufficient height to trigger the load detection system of an induction heating apparatus.

The dome may also include a heat retentive disc, insulation, a switched-circuit induction heating element, a thermal switch, a number of side RFID tags, and a top RFID tag. The remainder of the dome may be made primarily of heat retentive or heat insulative material.

The switched-circuit induction heating element is a circuit preferably formed of thin copper circuit trace that is etched or deposited on a backing layer of thin, high temperature polymer film. The heating element may comprise a string of individual secondary coils connected in series via connecting traces with like polarity such that current induced in any secondary coil by a primary coil of an induction heating element of an induction heating apparatus will drive current through the entire circuit path formed by the secondary coils.

The thermal switch has a switching temperature the same as or below a temperature of a thermal switch of the top RFID tag. The thermal switch may be an open-on-rise switch such that when the temperature of the thermal switch exceeds that of its designed switching temperature, its contacts open thus the electrical pathway of the switched-circuit induction heating element is no longer complete.

The side RFID tags are positioned near the sidewall so as not to be prohibited by the size or shape of the switched-circuit heating element. The top RFID tag includes a thermal switch and a parasitic antenna.

The dome includes specific data storage information in at least one of the RFID tags or in a dedicated memory. The information may include food being heated by the dome and information of an intended dining recipient or intended destination of the food. Additional data storage information may include a coded description of menu items such that a menu can be displayed for a service provider to know what is under the dome being served to the dining recipient and a room number location of the dining recipient.

The base may be similar to the dome except that it may be bowl-shaped, plate-shaped, or pan-shaped for supporting a dish or meal. The base may include insulation, heating components, temperature sensors, thermal switches, RFID tags, and the like similar to the dome as described above.

One of the induction heating apparatuses may includes a heating station, a hob, and a heating tower. The hob includes a substantially flat upper surface. The induction heating apparatus may include a work coil or other induction heating element configured to generate an electromagnetic field to inductively heat the dome. In one embodiment, the induction heating apparatus may be configured to only inductively heat the dome if the dome is resting flatly on the flat upper surface.

The heating tower includes an electronic system including a communication element, an RFID reader/writer, and other electronics and software to communicatively link, preferably by wireless protocol, the induction heating apparatus to the ordering system. The electronic system may write information corresponding to a food order to the memory of an RFID tag of the dome when the dome is docked with the induction heating apparatus.

Another induction heating apparatus may include a heating station, a number of guides, and a heating tower. The heating station may include a substantially flat upper surface. The induction heating apparatus may be configured to inductively heat a base. In one embodiment, the induction heating apparatus may only inductively heat the base if the base is resting flatly on the flat upper surface.

The delivery food carts may include stacked tray transport carts and room service carts. The stacked tray transport carts include an electronic system including a number of RFID readers and a number of transceivers or RFID antennas, and a rechargeable battery, one or more low power induction heaters, and a number of induction work coils. The stacked tray transport carts may be used for delivering a large number of meals to different destinations.

The RFID readers are positioned near tray storage locations within the cart and near a tray location at a top of the cart. The RFID antennas are positioned within the cart and/or near a top of the cart in proximity to the RFID readers. The RFID readers are communicatively coupled with a real-time clock configured to be set to and maintain a time and date of a location of the cart. The RFID readers are configured to read the information from RFID tags on the domes or bases positioned in or on the cart. The RFID readers are also Wi-Fi equipped to be configured to transmit information found on the RFID tags of one of the domes or bases and an associated date and time.

The RFID readers are configured to continuously search for RFID tags and may first read an identification number of any dome or base that is first placed inside or on the cart to be associated with a date and time stamp from the clock. The RFID readers are also configured to continue to determine the presence of that dome or base until it is removed from the cart, upon which the absence of that dome or base's identification number from the interrogation log of the particular RFID reader may indicate a date and time of removal.

The RFID readers are also configured to read an identification tag of a worker who placed the dome or base in or on the cart or removed the dome or base from the cart. The RFID readers are also configured to send this information via Wi-Fi to the central monitoring system to give real-time and logged data of a time history of a food delivery cycle associated with the dome or base.

The stacked tray transport cart is part of or communicatively linked to a real time location system (RTLS) whose tracking information can be transmitted to and logged by the central monitoring system. To facilitate this, the RFID readers are Wi-Fi enabled to connect to other devices in the communication network to be included in the RTLS.

The stacked tray transport cart also includes a user interface such as an LCD screen, integral tablet computer, or other display communicatively linked to the RFID readers. The user interface indicates to a meal delivery worker a list of meals that remain in the cart, their destinations, and intended recipients. When paired with the RTLS feature, the user interface also indicates a next delivery destination. The next delivery destination may be determined by a time sequence that the meals were loaded into the cart, the fastest delivery route to deliver all the meals in the cart, or some combination of time and delivery destination. An audio feature of the user interface may employ voice command and audio instructions to direct actions of the delivery worker.

The low power induction heater(s) are connected to the induction work coils such that there is one low-power induction inverter per induction work coil, which enhances reliability. The low power induction heater(s) employ RFID temperature control hardware and software. The low power induction heater(s) also employ a load detection system that will interrupt continuous production of an alternating magnetic field when a switched-circuit heating element's thermal switch opens a heating element's circuit of a dome or base.

Each induction work coil is dedicated to a different tray slot and positioned to be parallel with and/or slightly above domes or bases inserted in the cart to heat their heat retentive discs or parallel with and adjacent domes or bases inserted in the cart to heat their switched-circuit heating elements. The induction work coils continuously apply low amounts of energy to an inner surface of the dome or base during transport between a kitchen and a diner's room while preventing an over-temperature of the inner surface of the dome or base.

Each room service cart includes an electronic system including an RFID reader and a transceiver or RFID antenna, a rechargeable battery, one or more lower power induction heaters, and a number of induction work coils. The room service carts are used for delivering one or more meals to one or more room destinations.

The RFID reader is positioned near a top of the cart. The RFID antenna is positioned near the top of the cart in proximity to the RFID reader. The RFID reader is communicatively coupled with a real-time clock configured to be set to and maintain a time and date of a location of the cart. The RFID reader is configured to read the information from RFID tags on the domes or bases positioned on the cart. The RFID reader is also Wi-Fi equipped to be configured to transmit information found on the RFID tags of one of the domes or bases and an associated date and time.

The RFID reader is configured to continuously search for RFID tags and may first read an identification number of any dome or base that is first placed on the cart to be associated with a date and time stamp from the clock. The RFID reader is also configured to continue to determine the presence of that dome or base until it is removed from the cart, upon which the absence of that dome or base's identification number from the interrogation log of that RFID reader may indicate a time and date of removal.

The RFID reader is also configured to read an identification tag of a worker who placed the dome or base on the cart or removed the dome or base from the cart. The RFID reader may is also configured to send this information via Wi-Fi to the central monitoring system to give real-time and logged data of a time history of a food delivery cycle associated with the dome or base.

The room service cart is part of or communicatively linked to the aforementioned RTLS whose tracking information can be transmitted to and logged by the central monitoring system. To facilitate this, the RFID reader is Wi-Fi enabled to connect to other devices in the communication network to be included in the RTLS.

The room service cart also includes a user interface such as an LCD screen, integral tablet computer, or other display communicatively linked to the RFID reader. The user interface indicates to a meal delivery worker what meals remain on the cart and their destinations. When paired with the RTLS feature, the user interface also indicates a next delivery destination. The next delivery destination may be determined by a time sequence that the meals were placed on the cart, the fastest delivery route to deliver all the meals on the cart, or some combination of time and delivery destination. An audio feature of the user interface may employ voice command and audio instructions to direct actions of the delivery worker.

The low power induction heater(s) are connected to the induction work coils. Each induction work coil is dedicated to a different position on the cart to induce heating in domes or bases placed on the cart and may be located either on a top surface or a raised side surface of the cart. The low power induction heater(s) may employ RFID temperature control hardware and software. The low power induction heater(s) also employ a load detection system that will interrupt continuous production of an alternating magnetic field when a switched-circuit heating element's thermal switch opens a heating element's circuit of a dome or base.

The food delivery system is configured to inform a delivery worker, visually or audibly, what meals are on the delivery carts and their destinations. The food delivery system also tracks the location of each plate, food, dome, or base combination in real time, log in the central monitoring system the location, delivery time, and delivery person information for the entire life cycle of a delivery from induction heater outbound to the dining patron and back to the induction heater for each plate, food, dome, or base combination. The food delivery system also provides temperature regulated induction heating to the domes and bases transported in the carts. The food delivery system also may allow for motorized, automated delivery carts that are controlled by information provided by the ordering system, the central monitoring system, the communication network, and the various RFID reader/writers, RFID tags, identification tags of the food delivery system.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of a food delivery system constructed in accordance with an embodiment of the invention;

FIG. 2A is a perspective view of an induction heatable apparatus of the food delivery system of FIG. 1;

FIG. 2B is a partial cutaway view of the induction heatable apparatus of FIG. 2A;

FIG. 2C is a bottom perspective view of the induction heatable apparatus of FIG. 2A;

FIG. 3 is a perspective view of an induction heating apparatus of the food delivery system of FIG. 1;

FIG. 4 is a perspective view of another induction heating apparatus of the food delivery system of FIG. 1;

FIG. 5 is a perspective view of a food delivery cart of the food delivery system of FIG. 1;

FIG. 6 is a perspective view of another food delivery cart of the food delivery system of FIG. 1; and

FIG. 7 is a perspective view of another food delivery cart of the food delivery system of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

The following patents are incorporated by reference in their entireties herein: U.S. Pat. No. 6,320,169, entitled “METHOD AND APPARATUS FOR MAGNETIC INDUCTION HEATING USING RADIO FREQUENCY IDENTIFICATION OF OBJECT TO BE HEATED” by Clothier and filed on Sep. 6, 2000; U.S. Pat. No. 6,657,170, entitled “HEAT RETENTIVE INDUCTIVE-HEATABLE LAMINATED MATRIX” by Clothier and filed on May 20, 2002; U.S. Pat. No. 8,357,882, entitled “INDUCTION HEATED SERVER” by Jones and filed on May 13, 2010; U.S. Pat. No. 9,486,109, entitled “INDUCTION HEATING SYSTEM EMPLOYING INDUCTION-HEATED SWITCHED-CIRCUIT VESSELS” by Clothier and filed on Jul. 12, 2012; and U.S. Pat. No. 10,225,890, entitled “TEMPERATURE MEASUREMENT SYSTEM EMPLOYING AN ELECTROMAGNETIC TRANSPONDER AND SEPARATE IMPEDANCE-CHANGING PARASITIC ANTENNA” by Bourke, et al. and filed on Mar. 15, 2016.

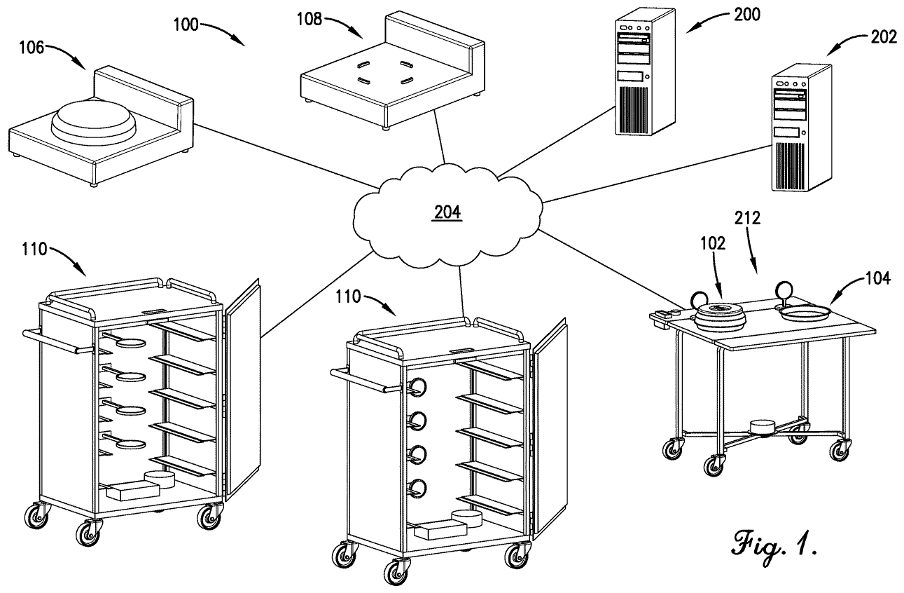

Turning to FIG. 1, a food delivery system 100 constructed in accordance with an embodiment of the invention is illustrated. The food delivery system 100 broadly comprises a plurality of induction-heatable apparatuses such as foodservice dome 102 and foodservice base 104, a plurality of induction heating apparatuses 106, 108, and a plurality of food delivery carts 110, 112. The food delivery system 100 may be configured to communicate and be used with an ordering system 200 and a central monitoring system 202 via a communication network 204. The food delivery system 100 may also utilize various worker identification tags.

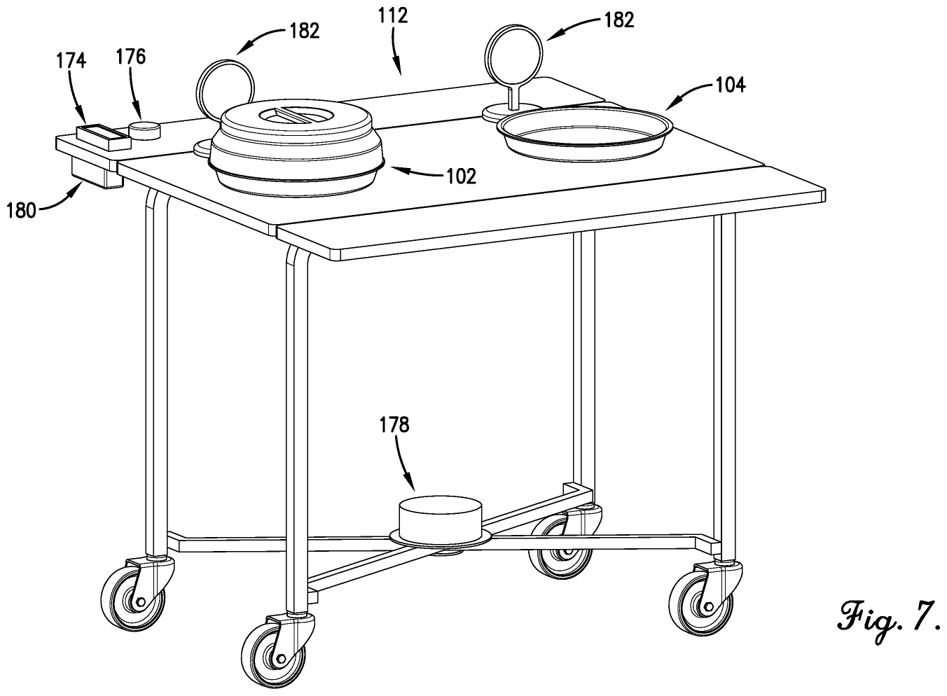

The induction-heatable apparatuses include a number of heatable foodservice domes (e.g., dome 102 shown in FIGS. 1-2C and 5-7) and a number of heatable foodservice bases (e.g., base 104 shown in FIGS. 1 and 7).

The dome 102 will now be described in more detail. The dome 102 may include a top wall 114 and a sidewall 116 extending downward from an outer edge of the top wall 114. An underside 118 of the top wall 114 may also include a guide structure 120. The dome 102 may also include an inner liner 122.

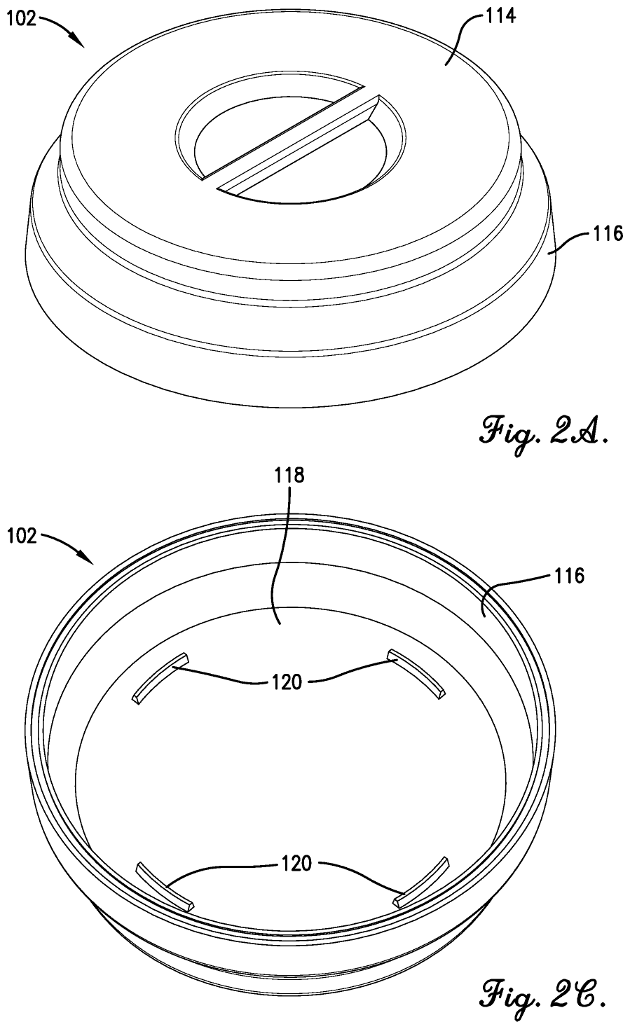

The guide structure 120 may be present if the dome 102 is larger than the hobs of the induction heating apparatuses (described below). The guide structure 120 may be protrusions, raised areas, tabs, or any other suitable features. The guide structure 120 may be spaced from the sidewall 116 and may be configured to ensure the underside 118 interfaces with the hobs of the induction heating apparatuses for proper charging (heating). The guide structure 120 may be molded onto the inner liner 122 or adhered by ultrasonic welding or adhesive. The dome 102 may thus have any shape or size yet can be positioned properly on the hob via the guide structure 120. In one embodiment, the guide structure 120 includes four raise arcs as shown in FIG. 2C. Other guiding structures may be used as long as they define a central area or diameter equal to that of the smallest dome to be used with the hob. In any event, the guide structure 120 should have sufficient height to trigger the load detection system of an induction heating apparatus 106 (described below). Some of the induction heatable apparatuses may be small domes that do not need guide structures because they fit neatly on the hobs by virtue of their size and shape.

The dome 102 may also include a heat retentive disc 124, insulation 126, a switched-circuit induction heating element 128, a thermal switch 130, a plurality of side RFID tags 132, and a top RFID tag 134, as best seen in FIG. 2B. The remainder of the dome 102 may be made primarily of heat retentive or heat insulative material.

The switched-circuit induction heating element 128 may be a circuit preferably formed of thin copper circuit trace that is etched or deposited on a backing layer of thin, high temperature polymer film such as Kapton™ film. The film and copper traces may be on the order of 0.001″ thickness. The heating element 128 may be formed of a larger film sheet and die cut to a desired size. The heating element 128 may comprise a string of individual secondary coils 136 (connected in series via connecting traces 138) with like polarity such that current induced in any secondary coil 136 by a primary coil of an induction heating element of an induction heating apparatus (described below) will drive current through the entire circuit path formed by the secondary coils 136. This will cause joule heating in the secondary coils 136 and connecting traces 138 which will transfer to the inner liner 122 of the dome 102. The heating element 128 may be cut in an elongated rectangular section of several secondary coils 136 arranged edge-to-edge. Alternatively, each secondary coil 136 may be die cut in separate identical pieces and separately adhered to the inner liner 122 to form a long strip of edge-to-edge secondary coils bounding the perimeter of the inner liner 122.

The secondary coils 136 may be sized so that they can be adhered in close thermal contact with the inner liner 201 while the connecting traces 138 are also in close thermal contact. To that end, the connecting traces 138 may be etched or deposited on opposite sides of the film from the secondary coils 136 with vias that allow an easy soldering process to electrically connect each secondary coil 136 to the connecting traces 138. This forms a continuous circuit path from one end 140 of the heating element 128 to the opposing end 142 of the heating element 128. Alternatively, the connecting traces 138 may be wires or produced via other manufacturing techniques.

The secondary coils 136 may be large enough to couple electromagnetic energy from a relatively smaller diameter primary work coil of a low power induction heater of one of the food delivery carts 110, 112 or a delivery tray. The secondary coils 136 may also be positioned close enough together such that at least one of the secondary coils 136 may be energized (i.e., energetically coupled) regardless of a random angular orientation of the dome 102. Current may then be driven throughout the circuit path from the energized secondary coil(s) 136. Possible changes to the heating element 128 may include a change of trace material to another metal or conductive material such as graphite. A shape of the secondary coils 136 may also be different from the shape depicted in FIG. 2C.

The thermal switch 130 may have a switching temperature the same as or below a temperature of a thermal switch of the top RFID tag 134. The thermal switch 130 may be connected between secondary coils 136 near the ends 140, 142 of the film/backing sheet to complete an electrical path of the switched-circuit induction heating element 128. The thermal switch 130 may be an open-on-rise switch such that when the temperature of the thermal switch 130 exceeds that of its designed switching temperature, its contacts open thus the electrical pathway of the switched-circuit induction heating element 128 is no longer complete. This open circuit will not significantly couple energy from the low-power induction heater and thus the temperature of the sidewall 116 of the dome 102 will not rise significantly above the switching temperature. A body of the thermal switch 130 should be positioned to make lasting thermal contact with at least a portion of the copper traces of the heating element 128. In one embodiment, the thermal switch 130 may be selected from the thermal switches described in the '169 patent and the '109 patent.

The side RFID tags 132 may be positioned near the sidewall 116 so as not to be prohibited by the size or shape of the switched-circuit heating element 128. As can be seen in FIG. 2C, there is sufficient room on the sidewall 116 for four side RFID tags 132 without negating the requirement for close radial proximity of the secondary coils 136 around the perimeter of the sidewall 116. The top RFID tag 134 may include a thermal switch 144 and a parasitic antenna 146.

The dome 102 may include specific data storage information in at least one of the RFID tags (side RFID tags 132 and top RFID tag 134) or in a dedicated memory. The information may include food being heated by the dome 102 and information of an intended dining recipient or intended destination of the food. Additional data storage information may include a coded description of menu items such that a menu can be displayed for a service provider to know what is under the dome 102 being served to the dining recipient and a room number location of the dining recipient. The side RFID tags 132 or top RFID tag 134 may be configured to transmit a response signal representing information of food and the information of intended recipient or intended destination upon receiving an interrogation signal.

The base 104 may be similar to the dome 102 except that it may be bowl-shaped, plate-shaped, or pan-shaped for supporting a dish or meal. The base may include insulation, heating components, temperature sensors, thermal switches, RFID tags, and the like similar to the dome 102 as described above.

The base 104 may also include specific data storage information in at least one of its RFID tags or in a dedicated memory. The additional data storage information may include a coded description of menu items such that a menu can be displayed for a service provider to know what is in the base 104 being served to a dining patron and a room number location of the dining patron.

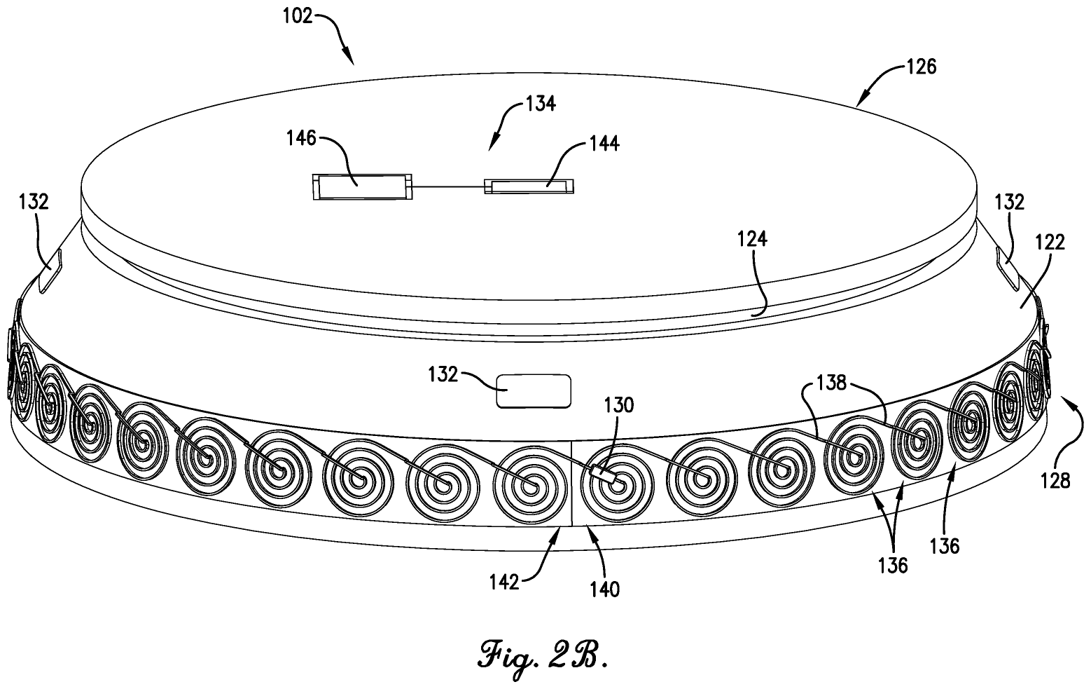

The induction heating apparatus 106 may include a heating station 148, a hob 150, and a heating tower 152, as shown in FIG. 3. The hob 150 may include a substantially flat upper surface 154. The induction heating apparatus 106 may include a work coil or other induction heating element configured to generate an electromagnetic field to inductively heat the dome 102. In one embodiment, the induction heating apparatus 106 may be configured to only inductively heat the dome 102 if the dome 102 is resting flatly on the flat upper surface 154. For example, if the dome 102 is misaligned on the hob 150 such that some of the guide structure 120 rests on the hob 150, the induction heating apparatus 106 may be un-activated. To that end, the induction heating apparatus 108 may include a load detection system that will not allow for continuous production of a magnetic field if the dome 102 is not centered over the hob 150.

The heating tower 152 may include an electronic system including a communication element, an RFID reader/writer, and other electronics and software to communicatively link, preferably by wireless protocol, the induction heating apparatus 106 to the ordering system 200 (e.g., an ordering or meal scheduling system of a healthcare or hospitality establishment such as a hospital, nursing home, hotel, resort, or convention center) to receive a signal representing ordering information from the ordering system 200 and to receive a signal representing information corresponding to a food order associated with the dome 102. The electronic system may be further configured to transmit a signal to write the information corresponding to the food order to the memory of an RFID tag of the dome 102 when the dome 102 is docked with the induction heating apparatus 106.

The communication link may be achieved via a Wi-Fi enabled RFID reader/writer of the induction heating apparatus 106. The communication link may allow receipt from the ordering system 200 of a pre-determined code or other information that corresponds to a description of a menu item that will be delivered using a specific dome that is presently being heated on the induction heating apparatus 106. The RFID reader/writer of the induction heating apparatus 106 may be configured to write this information to one or more of the RFID tags of the specific dome (preferably to a top RFID tag thereof) before, during, or after a heating cycle of the dome.

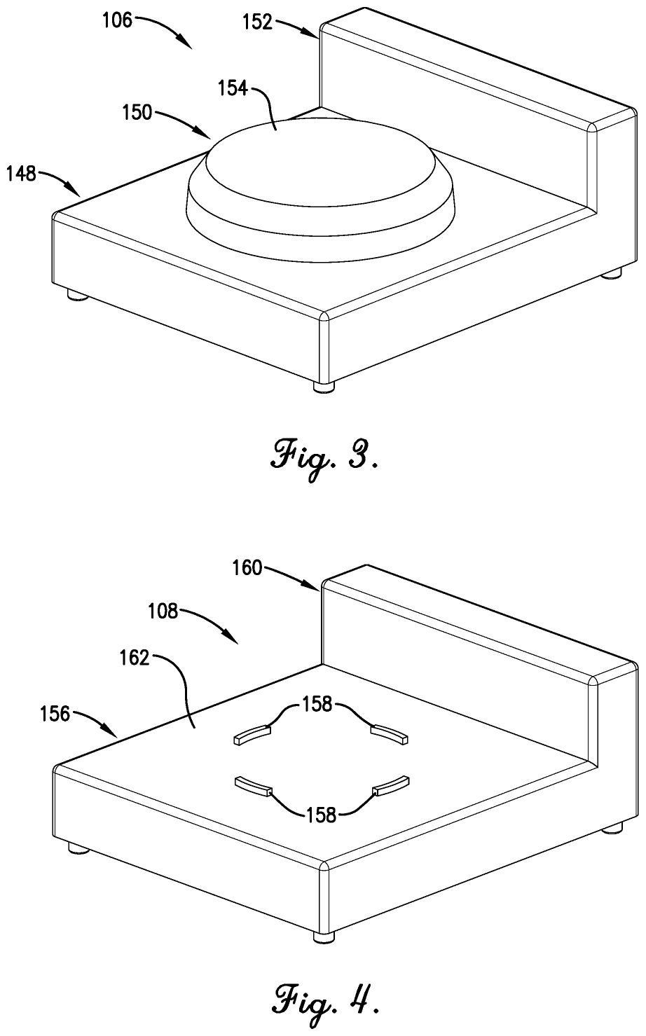

The induction heating apparatus 108 may include a heating station 156, a plurality of guides 158, and a heating tower 160, as shown in FIG. 4. The heating station 156 may include a substantially flat upper surface 162. The induction heating apparatus 108 may be configured to inductively heat the base 104. In one embodiment, the induction heating apparatus 108 may only inductively heat the base 104 if the base 104 is resting flatly on the flat upper surface 162. For example, if the base 104 is misaligned so that the base 104 is resting on some of the guides 158, the induction heating apparatus 108 may be un-activated.

The heating tower 160 may include an electronic system including a communication element, an RFID reader/writer, and other electronics and software to communicatively link, preferably by wireless protocol, the induction heating apparatus 108 to the ordering system 200 to receive a signal representing ordering information from the ordering system 200 and to receive a signal representing information corresponding to a food order associated with the base 104. The electronic system may be further configured to transmit a signal to write the information corresponding to the food order to the memory of an RFID tag of the base 104 when the base 104 is docked with the induction heating apparatus 108.

The communication link may be achieved via a Wi-Fi enabled RFID reader/writer of the induction heating apparatus 108. The communication link may allow receipt from the ordering system 200 of a pre-determined code or other information that corresponds to a description of a menu item that will be delivered using a specific base that is presently being heated on the induction heating apparatus 108. The RFID reader/writer of the induction heating apparatus 108 may be configured to write this information to one or more of the RFID tags of the specific base before, during, or after a heating cycle of the base.

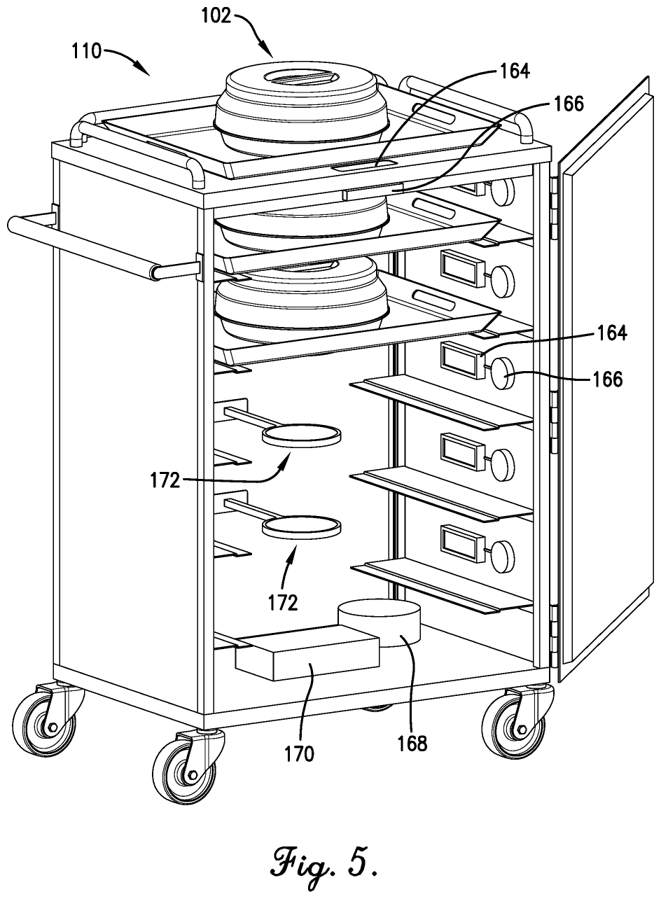

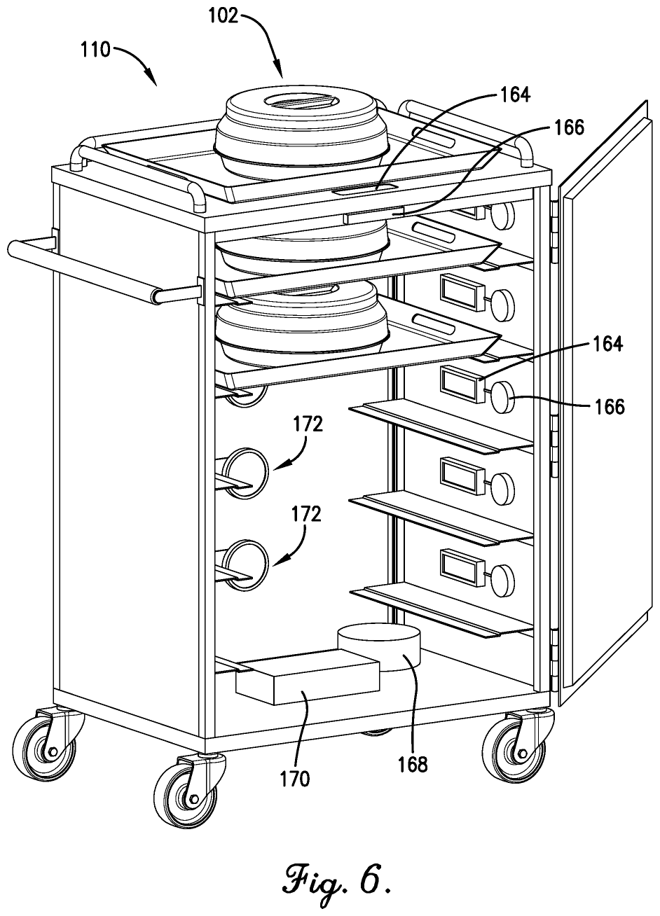

The delivery food carts 110, 112 may include stacked tray transport carts 110 (FIGS. 5 and 6) and room service carts 112 (FIG. 7). The stacked tray transport cart 110 will now be discussed in more detail.

The stacked tray transport carts 110 may include an electronic system including a plurality of RFID readers 164 and a plurality of transceivers or RFID antennas 166, and a rechargeable battery 168, one or more low power induction heaters 170, and a plurality of induction work coils 172. The stacked tray transport carts 110 may be used for delivering a large number of meals to different destinations.

The RFID readers 164 may be positioned near tray storage locations within the cart 110 and near a tray location at a top of the cart 110. The RFID antennas 166 may be positioned within the cart 110 and/or near a top of the cart 110 in proximity to the RFID readers 164. The RFID readers 164 and RFID antennas 166 may be powered by the rechargeable battery 168. The RFID readers 164 may be communicatively coupled with a real-time clock configured to be set to and maintain a time and date of a location of the cart 110. The RFID readers 164 may be configured to read the information from RFID tags 132, 134 on the domes or bases positioned in or on the cart 110. The RFID readers 164 may also be Wi-Fi equipped to be configured to transmit information found on the RFID tags 132, 134 of one of the domes or bases and an associated date and time as determined from the clock. Specifically, the RFID readers 164 may be configured to transmit a first interrogation signal and receive a response signal from the domes or bases positioned on the cart 110. The response signal may represent information corresponding to the food being warmed therein. This information may be augmented with information transmitted such as a date and time that a dome or base was added to and a date and time that the dome or base was removed from the cart 110. This information can be used transmitted via a report signal as live information to the central monitoring system 202 for monitoring or control and may add it to a database for future assessment.

The RFID readers 164 may be configured to continuously search for RFID tags and may first read an identification number of any dome or base that is first placed inside or on the cart 110 to be associated with a date and time stamp from the clock. The RFID readers 164 may also be configured to continue to determine the presence of that dome or base until it is removed from the cart 110, upon which the absence of that dome or base's identification number from the interrogation log of the particular RFID reader 164 may indicate a date and time of removal.

The RFID readers 164 may also be configured to read an identification tag (e.g., a bracelet including an RFID tag having worker identification information) of a worker who placed the dome or base in or on the cart 110 or removed the dome or base from the cart 110. The RFID readers 164 may also be configured to send this information via Wi-Fi to the central monitoring system 202 to give real-time and logged data of a time history of a food delivery cycle associated with the dome or base. Specifically, the RFID readers 164 may be configured to transmit a second interrogation signal, receive a response signal representing information corresponding to a worker from a work identification tag, associate the information corresponding to the worker with the augmented information, and transmit a report signal representing the information corresponding to the worker to the central monitoring system 202.

The stacked tray transport cart 110 may be part of or communicatively linked to a real time location system (RTLS) whose tracking information can be transmitted to and logged by the central monitoring system 202. To facilitate this, the RFID readers 164 may be Wi-Fi enabled to connect to other devices in the communication network 204 to be included in the RTLS. Additional software in the central monitoring system 202 may also allow Wi-Fi networks of hotels, convention centers, and resorts to be used for the RTLS to track the carts 110. Alternatively, active RFID tags such as the Airista Flow active RFID-over-Wi-Fi™ by Airista Flow, Inc. could be attached to the carts 110 to utilize an RTLS employing an existing Wi-Fi network.

The stacked tray transport cart 110 may also include a user interface such as an LCD screen, integral tablet computer, or other display communicatively linked to the RFID readers 164. The user interface may indicate to a meal delivery worker a list of meals that remain in the cart 110, their destinations, and intended recipients. When paired with the RTLS feature, the user interface may also indicate a next delivery destination. The next delivery destination may be determined by a time sequence that the meals were loaded into the cart 110, the fastest delivery route to deliver all the meals in the cart 110, or some combination of time and delivery destination. An audio feature of the user interface may employ voice command and audio instructions to direct actions of the delivery worker.

The rechargeable battery 168 may be positioned beneath or near a bottom floor of the cart 110. The rechargeable battery 168 may be configured to be wirelessly recharged via an associated docking station or via a power cord.

The low power induction heater(s) 170 may be connected to the induction work coils 172 such that there is one low-power induction inverter per induction work coil 172, which enhances reliability. The low power induction heater(s) 170 may employ RFID temperature control hardware and software described in the '169 patent and the '109 patent. The low power induction heater(s) 170 may also employ a load detection system that will interrupt continuous production of an alternating magnetic field when a switched-circuit heating element's thermal switch opens a heating element's circuit of a dome or base. The lower power induction heater(s) 170 may be powered by the rechargeable battery 168 and may output a maximum of approximately 50 watts each.

Each induction work coil 172 may be dedicated to a different tray slot and positioned to be parallel with and/or slightly above domes or bases inserted in the cart 110 to heat their heat retentive discs (as shown in FIG. 5) or parallel with and adjacent domes or bases inserted in the cart to heat their switched-circuit heating elements (as shown in FIG. 6). That is, one induction work coil per tray location may be configured to heat a heat retentive disc of a dome or base from above or to heat a switched circuit heating element around a periphery of a sidewall of the dome or base, with regulation provided by RFID temperature control technology described in the '169 patent and the '109 patent. The induction work coils 172 may continuously apply low amounts of energy to an inner surface of the dome or base during transport between a kitchen and a diner's room while preventing an over-temperature of the inner surface of the dome or base, thereby allowing the dome or base to have a less massive heat retentive disc and lower overall weight.

Each room service cart 112 may include an electronic system including an RFID reader 174 and a transceiver or RFID antenna 176, a rechargeable battery 178, one or more lower power induction heaters 180, and a plurality of induction work coils 182. The room service carts 112 may be used for delivering one or more meals to one or more room destinations.

The RFID reader 174 may be positioned near a top of the cart 112. The RFID antenna 176 may be positioned near the top of the cart 112 in proximity to the RFID reader 174. The RFID reader 174 and RFID antenna 176 may be powered by the rechargeable battery 178. The RFID reader 174 may be communicatively coupled with a real-time clock configured to be set to and maintain a time and date of a location of the cart 112. The RFID reader 174 may be configured to read the information from RFID tags 132, 134 on the domes or bases positioned on the cart 112. The RFID reader 174 may also be Wi-Fi equipped to be configured to transmit information found on the RFID tags 132, 134 of one of the domes or bases and an associated date and time as determined from the clock. Specifically, the RFID reader 174 may be configured to transmit a first interrogation signal and receive a response signal from the domes or bases positioned on the cart 112. The response signal may represent information corresponding to the food being warmed therein. This information may be augmented with information transmitted such as a date and time that a dome or base was added to and a date and time that the dome or base was removed from the cart 112. This information may be transmitted via a report signal as live information to the central monitoring system 202 for monitoring or control and may add it to a database for future assessment.

The RFID reader 174 may be configured to continuously search for RFID tags and may first read an identification number of any dome or base that is first placed on the cart 112 to be associated with a date and time stamp from the clock. The RFID reader 174 may also be configured to continue to determine the presence of that dome or base until it is removed from the cart 112, upon which the absence of that dome or base's identification number from the interrogation log of that RFID reader 174 may indicate a time and date of removal. The RFID reader 174 may also be configured to read an identification tag of a worker who placed the dome or base on the cart 112 or removed the dome or base from the cart 112. The RFID reader 174 may also be configured to send this information via Wi-Fi to the central monitoring system 202 to give real-time and logged data of a time history of a food delivery cycle associated with the dome or base. Specifically the RFID reader 174 may be configured to transmit a second interrogation signal, receive a response signal representing information corresponding to a worker from a work identification tag, associate the information corresponding to the worker with the augmented information, and transmit a report signal representing the information corresponding to the worker to the central monitoring system 202.

The room service cart 112 may be part of or communicatively linked to the aforementioned RTLS whose tracking information can be transmitted to and logged by the central monitoring system 202. To facilitate this, the RFID reader 174 may be Wi-Fi enabled to connect to other devices in the communication network 204 to be included in the RTLS. Additional software in the central monitoring system 202 may also allow Wi-Fi networks of hotels, convention centers, and resorts to be used for the RTLS to track the carts 110. Alternatively, active RFID tags such as the Airista Flow active RFID-over-Wi-Fi™ by Airista Flow, Inc. could be attached to the carts 110 to utilize an RTLS employing an existing Wi-Fi network.

The room service cart 112 may also include a user interface such as an LCD screen, integral tablet computer, or other display communicatively linked to the RFID reader 174. The user interface may indicate to a meal delivery worker what meals remain on the cart 112 and their destinations. When paired with the RTLS feature, the user interface may also indicate a next delivery destination. The next delivery destination may be determined by a time sequence that the meals were placed on the cart 112, the fastest delivery route to deliver all the meals on the cart 112, or some combination of time and delivery destination. An audio feature of the user interface may employ voice command and audio instructions to direct actions of the delivery worker.

The rechargeable battery 178 may be positioned near a bottom of the cart 112. The rechargeable battery 178 may be configured to be wirelessly recharged via an associated docking station or via a power cord.

The low power induction heater(s) 180 may be connected to the induction work coils 182. Each induction work coil 182 may be dedicated to a different position on the cart 112 to induce heating in domes or bases placed on the cart 112 and may be located either on a top surface or a raised side surface of the cart 112. The low power induction heater(s) 180 may employ RFID temperature control hardware and software described in the '169 patent and the '109 patent. The low power induction heater(s) 180 may also employ a load detection system that will interrupt continuous production of an alternating magnetic field when a switched-circuit heating element's thermal switch opens a heating element's circuit of a dome or base. The lower power induction heater(s) 180 may be powered by the rechargeable battery 178 and may output a maximum of approximately 50 watts each.

The induction work coils 182 may be configured to heat a heat retentive disc of a dome or base from above or to heat a switched circuit heating element around a periphery of a sidewall of the dome or base, with regulation provided by RFID temperature control technology described in the '169 patent and the '109 patent. The induction work coils 172 may continuously apply low amounts of energy to an inner surface of the dome or base during transport between a kitchen and a diner's room while preventing an over-temperature of the inner surface of the dome or base, thereby allowing the dome or base to have a less massive heat retentive disc and lower overall weight.

The food delivery system 100, via the above-described components and software is configured to inform a delivery worker, visually or audibly, what meals are on the delivery carts 110, 112 and their destinations. The food delivery system 100 also tracks the location of each plate, food, dome, or base combination in real time, log in the central monitoring system the location, delivery time, and delivery person information for the entire life cycle of a delivery from induction heater outbound to the dining patron and back to the induction heater for each plate, food, dome, or base combination. The food delivery system 100 also provides temperature regulated induction heating to the domes and bases transported in the carts 110, 112. The food delivery system 100 also may allow for motorized, automated delivery carts that are controlled by information provided by the ordering system 200, the central monitoring system 202, the communication network 204 (W-Fi network or other communication system), and the various RFID reader/writers, RFID tags, identification tags of the food delivery system 100.

### ADDITIONAL CONSIDERATIONS

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Patent claims stemming from this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An induction-heatable apparatus configured to be heated via an induction heating apparatus, the induction-heatable apparatus comprising:
a heat retentive body formed at least partially of heat-insulative material; and
an RFID tag including a memory configured to store:
information of food being heated by the heat retentive body; and
information of an intended recipient or intended destination of the food,
the RFID tag being configured to transmit a response signal representing the information of food and the information of intended recipient or intended destination upon receiving an interrogation signal.

2. The induction-heatable apparatus of claim 1, the induction-heatable apparatus being a dome including a sidewall and a top wall including an underside having a guide structure configured to ensure the bottom surface interfaces with the induction heating apparatus, the guide structure being spaced from the sidewall.

3. The induction-heatable apparatus of claim 1, the induction-heatable apparatus being a dome including a sidewall including an induction-heatable switched-circuit heating element configured to be inductively heated by an induction heater of a delivery cart or a delivery tray.

4. The induction-heatable apparatus of claim 1, the induction-heatable apparatus being a foodservice base.

5. The induction-heatable apparatus of claim 1, further comprising a heat retentive component.

6. An induction heating apparatus configured to heat an induction-heatable apparatus, the induction heating apparatus comprising:
an induction heating element configured to generate an electromagnetic field to heat the induction-heatable apparatus; and
an electronic system including a communication element configured to communicatively link to an ordering system so that the electronic system is configured to receive a signal representing ordering information from the ordering system.

7. The induction heating apparatus of claim 6, the electronic system being further configured to receive a signal representing information corresponding to a food order associated with the induction-heatable apparatus.

8. The induction heating apparatus of claim 7, the induction-heatable apparatus including an RFID tag including a memory, the electronic system being further configured to transmit a signal to write the information corresponding to the food order to the memory of the RFID tag when the induction-heatable apparatus is docked with the induction heating apparatus.

9. The induction heating apparatus of claim 8, the electronic system including an RFID reader/writer.

10. The induction heating apparatus of claim 6, the induction-heatable apparatus being a dome, the induction heating apparatus including a hob configured to interface with the dome.

11. A food delivery cart for delivering a first tray of food being warmed by a first induction-heatable apparatus and for use with a central monitoring system, the food delivery cart comprising:
a frame configured to support the first tray of food;
a first induction heating element configured to warm the induction-heatable apparatus and hence the food; and
an electronic system including:
an RFID reader configured to transmit a first interrogation signal and receive a response signal from the induction-heatable apparatus, the response signal representing information corresponding to the food, the electronic system being configured to augment the information corresponding to the food; and
a transmitter configured to transmit a report signal representing the augmented information corresponding to the food to the central monitoring system.

12. The food delivery cart of claim 11, the electronic system including a clock and being configured to augment the information with at least one of a date or time the tray of food was added to the food delivery cart and a date or time the tray of food was removed from the food delivery cart.

13. The food delivery cart of claim 11, the RFID reader being Wi-Fi enabled and further configured to:
transmit a second interrogation signal;
receive a response signal representing information corresponding to a worker from a worker identification tag;
associate the information corresponding to the worker with the augmented information; and
transmit a report signal representing the information corresponding to the worker to the central monitoring system.

14. The food delivery cart of claim 11, the electronic system further comprising a display interface communicatively connected to the RFID reader, the display interface being configured to display a list of food in the food delivery cart, intended recipients or destinations of the food in the list, a next recipient or destination based on at least one of a time sequence and a delivery route.

15. The food delivery cart of claim 11, further comprising a low-power induction heater configured to warm the induction-heatable apparatus, the electronic system being configured to effect temperature control of the induction-heatable apparatus and hence the food via the low-power induction heater during transportation of the food.

16. The food delivery cart of claim 11, the electronic system being further configured to transmit real time location system tracking information to the central monitoring system.

17. The food delivery cart of claim 11, the frame being configured to support a plurality of trays of food including the first tray of food, the plurality of trays of food being warmed by a plurality of induction-heatable apparatuses including the first induction-heatable apparatus, the food delivery cart including a plurality of induction heating elements including the first induction heating element for warming the plurality of trays of food.

18. The food delivery cart of claim 17, further comprising a plurality of low-power induction inverters each configured to power one of the plurality of induction heating elements.

19. The food delivery cart of claim 11, the first induction heating element being positioned to be parallel with and slightly above the induction-heatable apparatus.

20. The food delivery cart of claim 11, the first induction heating element being positioned to be parallel with and adjacent the induction-heatable apparatus.

21. A food delivery system for use with an ordering system and a central monitoring system, the food delivery system comprising:
an induction heating apparatus comprising:
an induction heating element configured to generate an electromagnetic field; and
an electronic system including a communication element configured to communicatively link to the ordering system so that the electronic system is configured to receive a signal representing ordering information from the ordering system;
an induction-heatable apparatus configured to be heated via the electromagnetic field of the induction heating apparatus, the induction-heatable apparatus comprising:
a body formed at least partially of heat-insulative material; and
an RFID tag including a memory configured to store:
information of food being heated by the heat retentive body; and
information of an intended recipient or intended destination of the food,
the RFID tag being configured to transmit a response signal representing the information of the food and the information of intended recipient or intended destination upon receiving an interrogation signal from the induction heating apparatus; and
a food delivery cart for delivering a tray of food being warmed by the induction-heatable apparatus, the food delivery cart comprising:
a frame configured to support the tray;
an induction heating element configured to warm the induction-heatable apparatus and hence the food; and
an electronic system including:
an RFID reader configured to transmit a first interrogation signal and receive a response signal from the induction-heatable apparatus, the response signal representing information corresponding to the food, the electronic system being configured to augment the information corresponding to the food; and
a transmitter configured to transmit a report signal representing the augmented information corresponding to the food to the central monitoring system.

22. The food delivery system of claim 21, the electronic system of the food delivery cart including a clock and being configured to augment the information with at least one of a date or time the tray of food was added to the food delivery cart and a date or time the tray of food was removed from the food delivery cart, the RFID reader of the food delivery cart being Wi-Fi enabled and further configured to:
transmit a second interrogation signal;
receive a response signal representing information corresponding to a worker from a worker identification tag;
associate the information corresponding to the worker with the augmented information; and
transmit a report signal representing the information corresponding to the worker to the central monitoring system.

23. The food delivery system of claim 21, the induction heating apparatus including a hob, the induction-heatable apparatus being a dome including a sidewall and a top wall including an underside having a guide structure configured to ensure the bottom surface interfaces with the hob, the guide structure being spaced from the sidewall.

24. The food delivery system of claim 21, the food delivery cart further comprising a low-power induction heater configured to warm the induction-heatable apparatus, the electronic system being configured to effect temperature control of the induction-heatable apparatus and hence the food via the low-power induction heater during transportation of the food.
